(19) United States
(12) Patent Application Publication
(10) Pub. No.: US 2026/0319123 A1
(43) Pub. Date: Oct. 15, 2026

(54) COIL SUSPENSION SYSTEM AND METHOD

(71) Applicant: Expert Geophysics Limited, Toronto (CA)

(72) Inventors: Andrei Bagrianski, Toronto (CA); Mikhail Kuzmin, Newmarket (CA)

(21) Appl. No.: 19/629,090

(22) Filed: Mar. 26, 2026

Related U.S. Application Data
(60) Provisional application No. 63/779,371, filed on Mar. 28, 2025.

(51) Int. Cl. G01V 3/10; G01V 3/16

(52) U.S. Cl. CPC G01V 3/104; G01V 3/16

(57) ABSTRACT

A geophysical survey receiver support system, including a coil frame configured to support a plurality of receiver coils and a suspension system to join the coil frame to external support points exterior to the coil frame. The suspension system includes a plurality of intermediate support structures, and a plurality of elastic interlink stages arranged in series from the coil frame to the exterior whereby the coil frame is to be suspended from the external support points. Two or more stages of the plurality of elastic interlink stages are disposed substantially within the coil frame.

### TECHNICAL FIELD

The disclosure relates to electromagnetic surveying, and particularly to suspension systems for geophysical prospecting coils.

### BACKGROUND

U.S. Pat. No. 10,627,535 purports to disclose an electromagnetic (EM) receiver system for measuring EM signals. This patent purports to disclose that the EM receiver system includes a platform; a coil for measuring EM signals; and first to third suspension mechanisms located between the platform and the coil so that the coil oscillates relative to the platform, and the first to third suspension mechanisms attenuate motion induced noise introduced by towing the receiver system above ground.

U.S. Pat. No. 9,817,147 purports to disclose an airborne electromagnetic receiver having a large dimension to allow low transmitter base frequency, and a modular and configurable suspension assembly for use within a receiver support structure and suspending the support structure. This patent purports to disclose that the suspension assembly has a rigid support having a suspension portion, and links connecting the suspension portion and the suspended structure, the links are adjustable in length and tension to radially suspend said equipment support structure. This patent purports to disclose that the natural frequency of the suspension assembly and the suspended receiver motion can be optimized by adjusting mass distribution, suspension link length and suspension link tension, the suspension assembly can be used to suspend a receiver having large receiver coils, the suspension assembly converts high frequency vibration forces imparted on the receiver to a low frequency oscillation, and the suspension assembly may also be tuned to avoid coincidence with the excitation frequencies.

U.S. Pat. No. 8,456,159 purports to disclose a stabilized field sensor apparatus which collects field data, in particular magnetic field data, with reduced motion noise. This patent purports to disclose that the apparatus includes a tear drop shaped housing, a tow frame in the housing, a plurality of vibration isolating dampers spaced around the frame, a base assembly mounted to the dampers, a support pedestal having a bottom end fixed to the base assembly and an upper free end, a single spherical air bearing connected to the upper free end of the pedestal, an instrument platform with a lower hollow funnel having an upper inside apex supported on the air bearing for a one point support, principal and secondary gyro stabilizers for maintaining pivotal and rotational stability, and at least one field sensor mounted to the instrument platform for collecting the field data while being stabilized against motion noise including vibration, pivoting and rotation from the base assembly, from the tow frame and from the housing. This patent purports to disclose that the stabilization of the instrument platform is enhanced by preserving accurate balance through a dynamic balancing system whereby small masses are moved under computer control to maintain the center of mass of the instrument platform at the center of rotation of the spherical air bearing. The dynamic stabilization process is made more precise by actively vibrating the instrument platform by a set of linear vibrators.

### SUMMARY

According to an aspect, there is provided a geophysical survey receiver support system, comprising: a coil frame configured to support a plurality of receiver coils; and a suspension system to join the coil frame to external support points exterior to the coil frame, the suspension system including: a plurality of intermediate support structures, and a plurality of elastic interlink stages arranged in series from the coil frame to the exterior whereby the coil frame is to be suspended from the external support points, the plurality of elastic interlink stages including a first end stage joining the coil frame to a first one of the plurality of intermediate support structures by a first end stage elastic interlink, a second end stage for joining the external support points to a second one of the plurality of intermediate support structures by a second end stage elastic interlink, and a further stage between the first and second intermediate support structures joining the first and second intermediate support structures via an intermediate stage elastic interlink, each of the elastic interlinks deformable and able to resume a rest shape after compression or extension, and wherein two stages of the plurality of elastic interlink stages are disposed substantially within the coil frame.

In some examples, the second end stage extends between a location inside the coil frame and a location outside the coil frame.

In some examples, the second end stage is the only stage of the plurality of elastic interlink stages that extends substantially outside the coil frame.

In some examples, only two stages of the plurality of elastic interlink stages are disposed substantially within the coil frame.

In some examples, each stage of the plurality of elastic interlink stages includes a plurality of elastic interlinks providing parallel support.

In some examples, the first end stage comprises a first plurality of elastic interlinks each extending between a first end connected to the coil frame and a second end connected to the first one of the intermediate support structures, the second end stage comprises a second plurality of elastic interlinks each extending between a first end connected to the second one of the intermediate support structures and a second end to be connected to an external support point of the external support points, and the further stage comprises a third plurality of elastic interlinks each extending between a first end connected to the first one of the intermediate support structures and a second end connected to the second one of the intermediate support structures.

In some examples, the first one of the intermediate support structures is a first plate.

In some examples, the second one of the intermediate support structures is a second plate extending generally parallel to the first plate.

In some examples, each of the first plurality of elastic interlinks of the first end stage of elastic interlinks is a length of silicone extending between the first end connected to the coil frame and the second end connected to the first plate, and each of the second plurality of elastic interlinks of the second end stage of elastic interlinks is a length of silicone extending between the first end connected to the second plate and the second end to be connected to the external support point.

In some examples, each of the third plurality of elastic interlinks of the intermediate stage of elastic interlinks is a length of silicone extending between the first end connected to the first plate and the second end connected to the second plate.

In some examples, the first ends of the plurality of elastic interlinks of each stage of the plurality of elastic interlink stages are generally regularly spaced apart from each other.

In some examples, the second ends of the plurality of elastic interlinks of each stage of the plurality of elastic interlink stages are generally regularly spaced apart from each other.

In some examples, the coil frame is configured to support three coils of the plurality of receiver coils in positions orthogonal to one another and with each of the three coils encircling an internal space within which the two internal stages of the plurality of elastic interlink stages are substantially disposed.

In some examples, the external support points are disposed outside the coil frame with the first end of each of the second plurality of elastic interlinks of the second end stage of elastic interlinks disposed within the coil frame and the second end of each of the second plurality of elastic interlinks of the second end stage of elastic interlinks disposed outside the coil frame and joined to the external support point.

According to another aspect, there is provided a method of using a geophysical survey receiver support system, comprising: suspending the coil frame from the external support points with the first plate above the second plate and the elastic interlinks of the intermediate stage under compression, and performing a geophysical survey by towing, while the first plate is above the second plate, the geophysical survey receiver system behind an aircraft while collecting data from the geophysical survey receiver system.

According to another aspect, there is provided a method of using the geophysical survey receiver support system of claim 14, comprising: suspending the coil frame from the external support points with the second plate above the first plate and the elastic interlinks of the intermediate stage under tension, and performing a geophysical survey by towing, while the second plate is above the first plate, the geophysical survey receiver system behind an aircraft while collecting data from the geophysical survey receiver system.

According to another aspect, there is provided a geophysical survey receiver support system, comprising: a coil frame configured to support a plurality of receiver coils; a structure forming external support points exterior to the coil frame; and a suspension system joining the coil frame to the external support points whereby the coil frame is suspended from the support, the suspension system including: a plurality of intermediate support structures, and a plurality of elastic interlink stages arranged in series between the coil frame and the exterior support points with an intermediate support structure of the plurality of intermediate support structures at each junction between stages of the plurality of elastic interlink stages, each intermediate support structure of the plurality of intermediate support structures including a plurality of connection locations at which elastic interlinks of two sequential ones of the plurality of elastic interlink stages are connected to the intermediate support structure, and wherein each of the plurality of connection locations of two of the plurality of intermediate support structures are disposed within the coil frame.

In some examples, the plurality of elastic interlink stages includes: a first end stage comprising a first plurality of elastic interlinks each extending between a first end connected to the coil frame and a second end connected to a first intermediate support structure of the plurality of intermediate support structures at a subset of the plurality of connection locations of the first intermediate support structure, a second end stage comprising a second plurality of elastic interlinks each extending between a first end connected to a second intermediate support structure of the plurality of intermediate support structures at a subset of the plurality of connection locations of the second intermediate support structure and a second end connected to an exterior support point of the exterior support points, and a further stage comprising a damper extending between a connection location of the plurality of connection locations of the first intermediate support structure and a connection location of the plurality of connection locations of the second intermediate support structure, and wherein the plurality of connection locations of the first intermediate support structure and the plurality of connection locations of the second intermediate support structure are disposed within the coil frame.

According to an aspect, there is provided a kit of parts for assembly into a geophysical surveying receiver support system, the kit of parts including: a coil frame configured to support a plurality of receiver coils; a plurality of intermediate support structures; a first plurality of elastic interlinks each extending between a first end to be connected to the coil frame and a second end to be connected to a first one of the plurality of intermediate support structures, the first plurality of elastic interlinks to be arranged in parallel to form a first end stage of elastic interlinks; a second plurality of elastic interlinks each extending between a first end to be connected to a second one of the plurality of intermediate support structures and a second end to be connected to a suspension platform, the second plurality of elastic interlinks to be arranged in parallel to form a second end stage of elastic interlinks; and a third plurality of elastic interlinks each extending between first and second ends, the third plurality of elastic interlinks to be arranged in parallel to form an intermediate stage of elastic interlinks in series between the first and second end elastic interlink stages.

In some examples, the first one of the plurality of intermediate support structures is a first plate and the second one of the plurality of intermediate support structures is a second plate, and each of the elastic interlinks of the first, second, and third pluralities of elastic interlinks is a length of silicone.

### BRIEF DESCRIPTION OF THE DRAWINGS

The drawings included herewith are for illustrating various examples of systems, methods, and apparatus of the present specification. In the drawings:

FIG. 1A is a side view of an example geophysical survey system;

FIG. 1B is a top view of the geophysical survey system of FIG. 1A;

FIG. 2A is top perspective view of an example geophysical survey receiver support system;

FIG. 2B is a top perspective transparent view of the geophysical survey receiver support system of FIG. 2A;

FIG. 2C is a top perspective transparent view of a portion of the geophysical survey receiver support system of FIG. 2A;

FIG. 3 is a flow chart of a method of using a geophysical survey receiver support system;

FIG. 4A is a bottom perspective view of another example geophysical survey receiver support system;

FIG. 4B is a bottom perspective transparent view of the geophysical survey receiver support system of FIG. 4A;

FIG. 5A is a top perspective view of a portion of another example geophysical survey receiver support system;

FIG. 5B is a top perspective view of a damper of the geophysical survey receiver support system of FIG. 5A;

FIG. 6 is a side perspective view of an example coil frame,

FIG. 7 is top perspective view of portions of another example geophysical survey receiver support system,

FIG. 8 is a top plan view of portions of the geophysical survey receiver support system of FIG. 7, and

FIG. 9 is a side view of the portions of the geophysical survey receiver support system of FIG. 8.

### DETAILED DESCRIPTION

Various apparatuses, assemblies, or processes will be described below to provide an example of an embodiment of each claimed invention. No embodiment described below limits any claimed invention and any claimed invention may cover apparatuses, assemblies, or processes that differ from those described below. The claimed inventions are not limited to apparatuses, assemblies, or processes having all of the features of any one apparatus, assembly, or process described below or to features common to multiple or all of the apparatuses, assemblies, or processes described below. It is possible that an apparatus, assembly, or process described below is not an embodiment of any claimed invention. Any invention disclosed in an apparatus, assembly, or process described below that is not claimed in this document may be the subject matter of another protective instrument, for example, a continuing patent application, and the applicants, inventors, or owners do not intend to abandon, disclaim, or dedicate to the public any such invention by its disclosure in this document. Like reference numbers represent corresponding parts throughout.

The present disclosure relates to geophysical survey receiver support systems. The geophysical survey receiver support system is useable as part of a geophysical survey system for electromagnetic surveying. In some examples, the geophysical survey receiver is part of an electromagnetic survey system for use in mapping resources, such as minerals, aquifers, or geological formations. Electromagnetic surveys involve measuring secondary magnetic fields near Earth's surface, which are generated by primary magnetic fields' interaction with the local subsurface, which in turn are sourced from either man-made transmitters (i.e., an active electromagnetic survey) or natural emissions like lightning (i.e., a passive electromagnetic survey). The depth at which these fields penetrate the Earth depends on ground conductivity and frequency. Due to the skin effect of conductors, lower frequency electromagnetic waves penetrate the Earth deeper than higher frequency waves. To maximise the depth of investigation of a passive survey technique, a low frequency response of a system should also be maximised. Receivers like inductive coils or magnetometers can be used to capture the magnetic field components of the signals, which are amplified, filtered, and digitized. The data, along with positioning information (e.g., GPS positioning), helps create conductivity contour maps through post-processing when combined with data from a stationary ground-based electromagnetic reference station.

In some examples, the geophysical survey receiver support of the present disclosure is used as part of a passive electromagnetic survey. The passive technique of measuring environmental electromagnetic signals, known as Magneto Tellurics, may be particularly limited by the ability of the system to isolate low frequency noise, especially when operated from an airborne platform. These surveys generally require high signal-to-noise ratios (SNR) and resolution, which vary based on ground conductivity and desired depth of investigation. In some examples, the frequency spectrum being measured spans from 20 kHz to approaching 0 Hz. There are many sources of noise present, particularly in airborne systems, including external sources such as radio frequency transmissions, as well as system-derived sources such as the quiescent noise of amplification circuitry and microphonic noise picked up by the electromagnetic coils through aerodynamic buffeting. Each source of noise affects different bands of the frequency spectrum. Aerodynamic buffeting is typically the main cause of the lower frequency bound which can be measured while the system is in forward motion due to the dynamic nature of vibrations created in the aircraft's flight (e.g., a helicopter's flight) as well as aerodynamic effects on a sensor shell as it travels through the air. This particular noise appears in the 0 -20 Hz range and is directly correlated to forward velocity.

To minimise mechanical noise, especially that in the lowest frequency range, a geophysical survey receiver support system incorporating multi-stage suspension between a suspension frame and a coil frame provided to support a plurality of receiver coils is disclosed. A geophysical survey receiver support system incorporating multi-stage suspension helps absorb and dampen low frequency impulses and improve measurement accuracy. A significant portion of the suspension system is located within the coil frame. This helps reduce the dimensions of the support system and allow the support system to further help absorb and dampen low frequency impulses and improve measurement accuracy. In some examples, the geophysical survey receiver support system incorporating multi-stage suspension includes a series of elastic interlink stages, including two stages disposed substantially within the coil frame. In some examples, the geophysical survey receiver support system incorporating multi-stage suspension includes a series of intermediate support structures providing connection locations for elastic interlinks, and all the connection locations on two support structures are disposed substantially within the coil frame. In some examples, the geophysical survey receiver support system incorporating multi-stage suspension includes a series of elastic interlink stages, and only the second end stage directly coupled to the suspension frame extends substantially outside the coil frame.

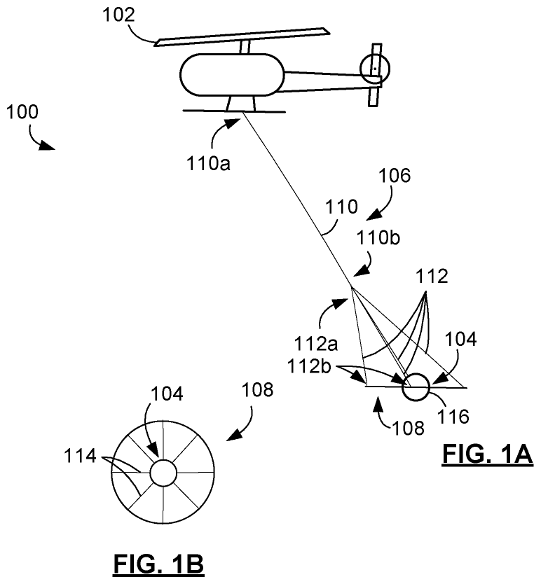

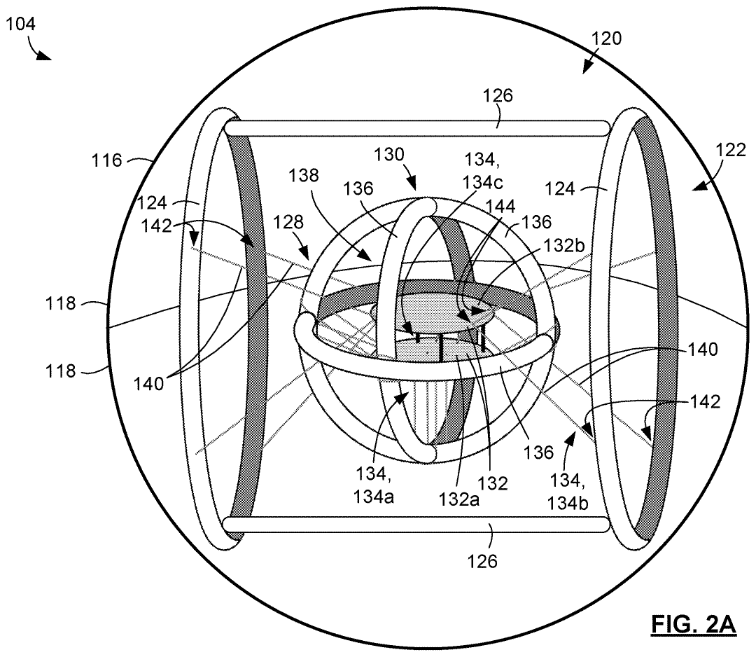

Referring to FIG. 1A, illustrated is an example geophysical survey system 100 shown in a side view. The geophysical survey system includes a vehicle 102 and a receiver system 104. The receiver system 104 is secured to the vehicle 102 to be carried by the vehicle 102. In some examples, the vehicle 102 is an aircraft. In the illustrated example, the vehicle 102 is a helicopter. The receiver system 104 may be secured to the aircraft by a tow system 106 by which the aircraft tows the receiver system 104 in use. In some examples, the receiver system 104 is used in a passive survey system without a transmitter system. In some examples, the survey system 100 is an active survey system and also includes a transmitter system 108. The transmitter system 108 is secured to the vehicle 102 to be carried by the vehicle. In the illustrated example, the receiver system 104 is secured to the vehicle 102 via the transmitter system 108, with the tow system 106 including a first line 110 and branch lines 112, with a first end 110a of the first line 110 secured to the vehicle 102, first ends 112a of the branch lines 112 secured to a second end 110b of the first line, and second ends 112b of the branch lines 112 secured to the transmitter system 108. Referring to FIG. 1B, illustrated is a top view of the receiver and transmitter systems 104, 108, showing lines 114 joining the transmitter system 108 to the receiver system 104, via which the receiver is secured to the vehicle 102.

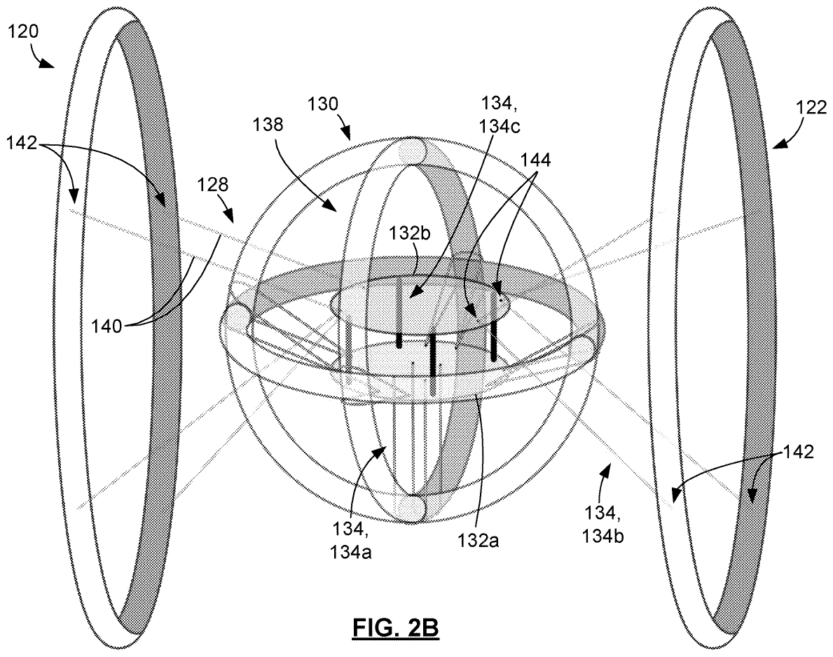

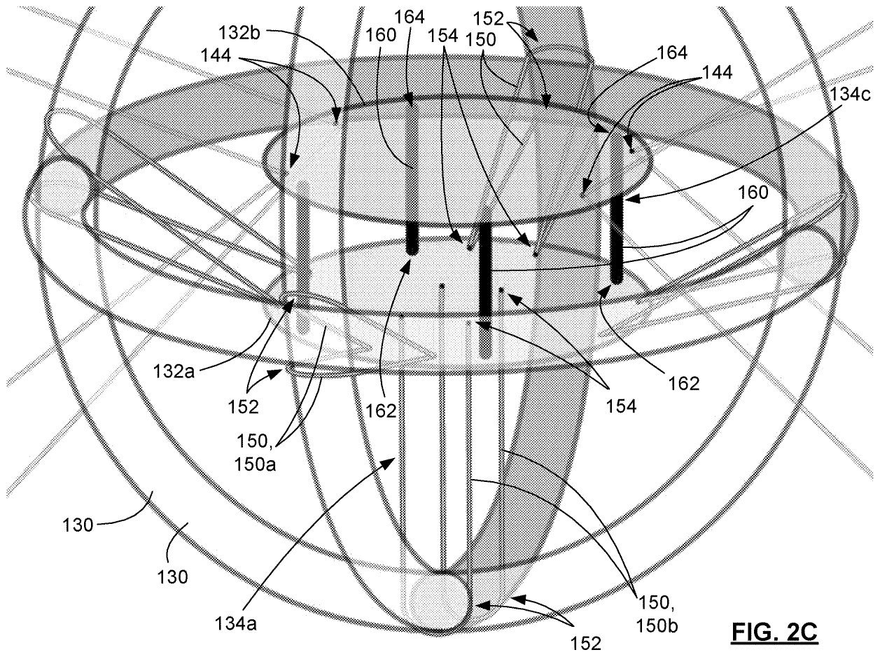

Referring now to FIGS. 2A and 2B, illustrated is an example receiver system 104. The receiver system 104 includes a geophysical survey receiver support system 120. In the illustrated example, the geophysical survey receiver support system 120 is enclosed in a protective shell 116. In the illustrated example, the shell 116 is an openable shell with a plurality of separable portions 118 (e.g., upper and lower halves). In some examples, the shell 116 is generally spherical. In some examples, the shell 116 is formed of polycarbonate and/or fiberglass.

In use, the geophysical survey receiver support system 120 suspends the receiver coils from external support points 142 outside the coil frame on a support body or structure. Any suitable support body or structure may be used. In some examples, in use, the support system 120 suspends the receiver coils from support points on a suspension frame 122. Any suitable suspension frame may be used. In the illustrated example, the suspension frame 122 includes two rings 124 at a fixed distance apart. The rings 124 may be fixed apart in any suitable way. In the illustrated example, the rings 124 are joined by rigid rods 126. Alternatively, in some examples, the suspension frame 122 is not included. In some examples, in use, the support system 120 suspends the receiver coils from support points 142 on the shell 116.

The geophysical survey receiver support system 120 includes a coil frame 130. The coil frame 130 is configured to support a plurality of receiver coils. In some examples, the coil frame 130 is a single-piece body (i.e., unitary construction). This helps avoid noise from movement between pieces. A receiver coil extends generally in a plane. In some examples, the coil frame 130 is configured to support three receiver coils in positions generally orthogonal to one another. The coil frame 130 may support more than three receiver coils. In the illustrated example, the coil frame 130 is configured to support three receiver coils with each of the three coils encircling an internal space 138. The illustrated example coil frame 130 is a generally spherical coil frame which includes three coil supports 136 each forming an annular surface to support a receiver coil. The coil frame 130 has gaps between coil supports 136 to allow the passage of interlinks by which the coil frame is suspended. The support points 142 are disposed outside the coil frame 130. In some examples, the coil frame is formed of substantially pure polycarbonate or 3d-printed carbon-impregnated polycarbonate. In some examples, the coil frame is as rigid as possible to help avoid producing vibrations under dynamic load. The coils rest on the coil frame and so the coil frame should stay inert. In some examples, the coil frame is formed by additive manufacturing (e.g., 3D printing) and designed to be as light as possible without developing resonances. In some examples, the coil frame is not formed by additive manufacturing and is designed to be stable and vibrationally inert.

The geophysical survey receiver support system 120 includes a suspension system 128 joining the coil frame 130 to the suspension frame 122. The suspension system 128 includes a plurality of intermediate support structures 132 and a plurality of elastic interlink stages 134. The plurality of elastic interlink stages 134 are arranged in series between the suspension frame and the coil frame. The coil frame 120 is suspended from the suspension frame 122 through the series of elastic interlink stages 134. In some examples, the elastic interlinks of different stages have different lengths, tensions, materials, and/or thicknesses. This helps reduce the dimensions of the support system and allow the support system to further help absorb and dampen low frequency impulses and improve measurement accuracy.

A significant portion of the suspension system 128 is disposed within the coil frame. This helps reduce the dimensions of the support system and allow the support system to further help absorb and dampen low frequency impulses and improve measurement accuracy. In some examples, two stages 134 of the plurality of elastic interlink stages are disposed substantially within the coil frame 130. For example, in some embodiments two stages 134 of the plurality of elastic interlink stages are disposed substantially within the internal space 138. In some examples, a third or further stage is also disposed substantially within the coil frame 130. In some examples, these stages are sequential stages in the suspension system 128. In some examples, these stages include a first end stage joining the coil frame 130 to the first intermediate support structure.

The suspension system 128 includes a first end stage 134a joining the coil frame 130 to a first one 132a of the plurality of intermediate support structures 132. The suspension system 128 includes a second end stage 134b joining a second one 132b of the plurality of intermediate support structures 132 to the suspension frame 122. The suspension system 128 includes a further stage 134c between the first one 134a and the second one 134b of the intermediate support structures 134. In the illustrated example, the suspension system 128 includes only one further stage 134c and the further stage 134c joins the first one 132a and the second one 132b of the intermediate support structures 132. In some examples, only the second end stage 134b directly connected to the suspension frame extends substantially outside the coil frame, the rest of the stages 134 are disposed substantially within the coil frame.

Referring still to FIGS. 2A and 2B, the second end stage 134b includes a plurality of elastic interlinks 140. The elastic interlinks 140 each extend between an external support point 142 (e.g., on the suspension frame 122 in the illustrated example, or alternatively on another external structure such as the shell) and a second connection location 144 on the second intermediate support structure 132b. In the illustrated example, the system includes a plurality of discrete external support points 142 and a plurality of discrete second connection locations 144 to distribute support. In the illustrated example, a plurality of discrete elastic interlinks 140 are included in the second end stage 134b. This helps absorb and dampen low frequency impulses and improve measurement accuracy. Any suitable elastic interlinks 140 may be used. In some examples, the elastic interlinks 140 each include a length of plastic tubing. In some examples, the elastic interlinks 140 each include a length of silicone tubing. In the illustrated example, the elastic interlinks 140 each include a length of solid-core tubing. Alternatively, the tubing may be hollow-core. In some examples, the lengths have a diameter of between 0.25 inches to 0.5 inches, inclusive. In some examples, the interlinks 140 have a generally common length, generally common thickness, generally common tension, and/or are made of a generally common material between the different interlinks 140 forming the stage.

In the illustrated example, the interlinks 140 are formed of discrete lengths of material, each interlink 140 formed by one length of material. The second end stage 134b of the illustrated example includes eight lengths, each fixed at one end to an external support point 142 and fixed at the other end at a second connection location 144 to the second intermediate support structure 132b. Forming each interlink 140 from a separate length helps avoid losing multiple interlinks 140 if a length breaks. Alternatively, in some examples, a length may be wrapped back, e.g., with a length secured at one end of the length to a first external support point and the other end of the length secured to a second external support point with a middle of the length extending through a hole in the second intermediate support structure.

Referring now to FIG. 2C, the first end stage 134a includes a plurality of elastic interlinks 150. The elastic interlinks 150 each extend between a first connection location 152 on the coil frame 130 and a second connection location 154 on the first intermediate support structure 132a. In the illustrated example, the system includes a plurality of discrete first connection locations 152 and a plurality of discrete second connection locations 154 to distribute support. In the illustrated example, a plurality of discrete elastic interlinks 150 are included in the first end stage 134a. This helps absorb and dampen low frequency impulses and improve measurement accuracy. In some examples, each interlink 150 is a single length of material discrete from other interlink 150, with the length of material joined at one end to the coil frame 130 and joined at the opposite end to the first intermediate support structure. For example, the system may include one length of material forming each interlink 150 discrete from each other interlink 150, each length secured at one end to the first intermediate support structure and at the other, opposite end to the coil frame. Alternatively, an interlink 150 may be part of a length that also forms another interlink (e.g., wrapped over or through another structure and doubling back to form a further interlink).

In the illustrated example, the first end stage 134a includes a first plurality of elastic interlinks 150a extending generally horizontally and a second plurality of elastic interlinks 150b extending generally vertically. In some examples, the first plurality of elastic interlinks 150a extends generally parallel to elastic interlinks 140 of the second end stage 134b. In some examples, the second plurality of elastic interlinks 150b extends generally parallel to elastic interlinks of an intermediate stage. This helps absorb and dampen low frequency impulses and improve measurement accuracy. Alternatively, the first end stage 134a may include the first plurality of elastic interlinks 150a (e.g., generally horizontally) and not include the second plurality of elastic interlinks 150b. For example, the first end stage may include eight lengths of material each having a first end secured to a point 154 and having a second end secured at a point 152, and in some examples all eight points 152 are in in a common plane and/or all eight points 154 are in in a common plane.

Any suitable elastic interlinks 150 may be used. In some examples, the elastic interlinks 150 each include a length of plastic tubing. In some examples, the elastic interlinks 150 each include a length of silicone tubing. In the illustrated example, the elastic interlinks 150 each include a length of solid-core tubing. In some examples, an interlink 150 includes a high-temperature silicone rubber rod such as those available from McMaster-Carr™. In some examples, the interlinks 150 each include a length of hollow-core tubing. In some examples, an interlink 150 includes a silicone tubing hose such as those available from MECCANIXITY™. In some examples, the interlinks 150 have a generally common length, generally common thickness, generally common tension, and/or are made of a generally common material between the different interlinks 150 forming the stage. In some examples, an interlink 150 and an interlink 140 have a generally different length, generally different thickness, generally different tension, and/or are made of a generally different material.

Referring still to FIG. 2C, the intermediate stage 134c includes a plurality of elastic interlinks 160. The elastic interlinks 160 each extend between a first connection location 162 on a first one of the intermediate support structures and a second connection location 164 on a second one of the intermediate support structures. In the illustrated example, the system includes only a single intermediate stage 134c, and for each elastic interlink 160 the first connection location 162 is on the first intermediate support structure 132a and the second connection location 164 is on the second intermediate support structure 132b. In the illustrated example, the system includes a plurality of discrete first connection locations 162 and a plurality of discrete second connection locations 164 to distribute support. In the illustrated example, a plurality of discrete elastic interlinks 160 are included in the intermediate stage 134b. This helps absorb and dampen low frequency impulses and improve measurement accuracy. Any suitable elastic interlinks 140 may be used. In some examples, the elastic interlinks 160 each include a length of plastic tubing. In some examples, the elastic interlinks 160 each include a length of silicone tubing. In the illustrated example, the elastic interlinks 160 each include a length of hollow silicone tubing. In the illustrated example, the system includes four interlinks 160 in the intermediate stage. Alternatively, an intermediate stage may include another number of interlinks 160. In some examples, the system includes eight discrete interlinks 160 in a single intermediate stage.

In some examples, the interlinks 160 have a generally common length, generally common thickness, generally common tension, and/or are made of a generally common material between the different interlinks 160 forming the stage. In some examples, an interlink 160 and an interlink 150 have a generally different length, generally different thickness, generally different tension, and/or are made of a generally different material. In some examples, an interlink 160 and an interlink 140 have a generally different length, generally different thickness, generally different tension, and/or are made of a generally different material.

The intermediate support structures 132 provide connection locations for the elastic interlinks. Each intermediate support structure 132 includes a plurality of connection locations (e.g., connection locations 144, 154, 162, and/or 164) at which ends of elastic interlinks of a first one the plurality of elastic interlink stages of a subsequent one the plurality of elastic interlink stages are connected to the intermediate support structure. In the illustrated example, the system includes only two intermediate support structures 132. In some examples, the intermediate support structures 132 are rigid structures providing connection locations at fixed positions relative to one another.

In some examples, an intermediate support structure 132 comprises or consists of a plate. In some examples, the plate is a single-piece body (i.e., unitary construction). In some examples, the plate has connection locations for elastic interlinks adjacent a periphery of the plate. In some examples, the connection locations for elastic interlinks are only adjacent a periphery of the plate. In the illustrated example, the second intermediate support structure 132b includes a plate and all of the connection locations 144 on the second intermediate support structure 132b are adjacent a periphery of the plate. In the illustrated example, the first intermediate support structure 132a includes a plate and some of the connection locations 154 on the first intermediate support structure 132a are adjacent a periphery of the plate. In the illustrated example, the plate of the first intermediate support structure 132a includes connection locations 154 also near a centre of the plate.

In the illustrated example, the suspension system includes two plates 132a, 132b extending generally parallel to one another. In the illustrated example, the intermediate stage 134c is secured to a first surface of a first plate and to a second surface of a second plate, the first surface and the second surface extending generally parallel to one another and facing one another. In the illustrated example, the intermediate support structures 132 are disc-shaped plates. Disc shapes help maximize the room for the coil frame to move in this suspension. In some examples, cutouts are added for more interlink clearance and/or to reduce the harmonic balances in the plates, for example an intermediate support structure may be a plate with a rounded square or diamond shape, offset at 45 degrees between layers.

In some examples, all of the connection locations on two intermediate support structures 132 are located substantially within the coil frame 130. This helps reduce the dimensions of the support system and allow the support system to further help absorb and dampen low frequency impulses and improve measurement accuracy. For example, in some embodiments all of the connection locations on two intermediate support structures 132 are located substantially within the internal space 138. In some examples, all the connection locations on a third or further intermediate support structure 132 are substantially located within the coil frame 130 also. In some examples, the entirety of two intermediate support structures 132 are located substantially within the coil frame 130. In the illustrated example, the first and second intermediate support structures each comprise a plate, and the entire plate of the first intermediate support structure is within the coil frame and the entire plate of the second intermediate support structure is within the coil frame.

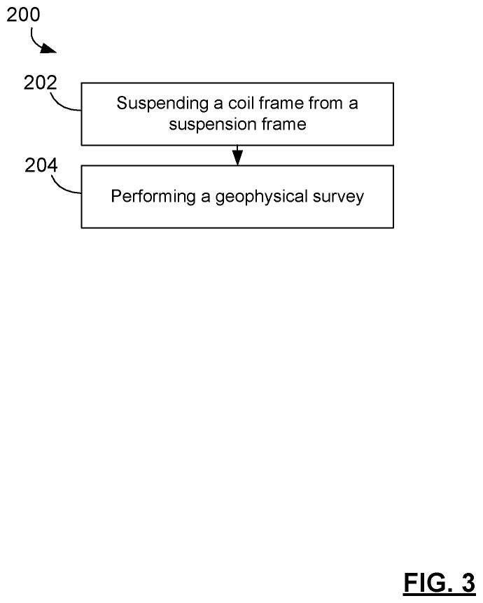

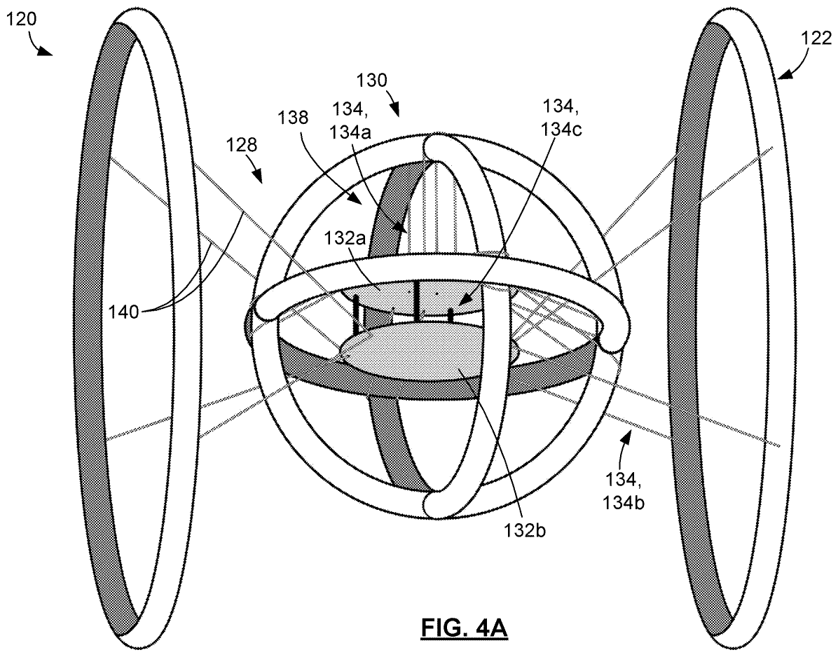

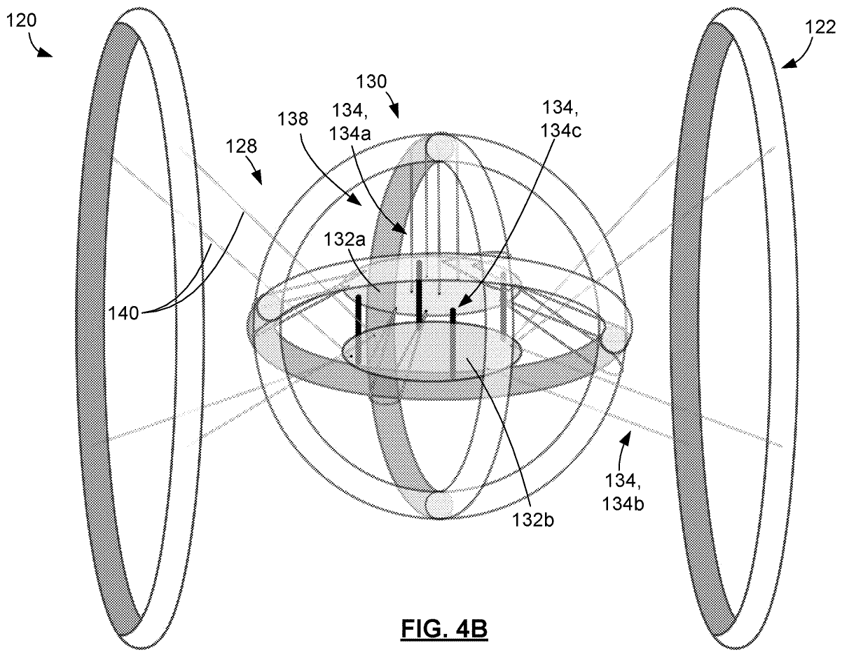

Referring now to FIG. 3, illustrated is a flow chart of a method 200 of using the geophysical survey receiver support system 120. The method 200 includes, at step 202, suspending the coil frame 130 from the suspension frame 122 via the series of elastic interlink stages 134 of the suspension system 128. In some examples, during step 202 the first intermediate support member 132a is below (relative to gravity) the second intermediate support member 132b. Alternatively, in some examples, during step 202 the second intermediate support member 132b is below (relative to gravity) the first intermediate support member 132a. An example configuration in which the second intermediate support member 132b is below the first intermediate support member 132a is illustrated in FIGS. 4A and 4B. When the first intermediate support member 132a is below the second intermediate support member, the intermediate stage 134c is under tension. When the second intermediate support member 132b is below the first intermediate support member 132a, the intermediate stage 134c is under compression. In some examples, the inventors have discovered that a tension-style support communicates fewer low frequency vibrations than the compression-style support.

At step 204, method 200 includes performing a geophysical survey. Step 204 includes towing the geophysical survey receiver system behind a vehicle while collecting data from the receiver system. In some examples, that vehicle is an aircraft. In some examples, that vehicle is a helicopter. In some examples, step 204 also includes towing a geophysical survey transmitter system behind the vehicle while transmitting from the geophysical survey transmitter system and collecting data from the receiver system. In some examples, step 204 is performed while the first intermediate support member is above the second intermediate support member. In some examples, step 204 is performed while the second intermediate support member is above the first intermediate support member. In some examples, an intermediate step between steps 202 and 204 includes tuning the suspension to ensure the sensor is hanging in balance and the suspension between layers is balanced.

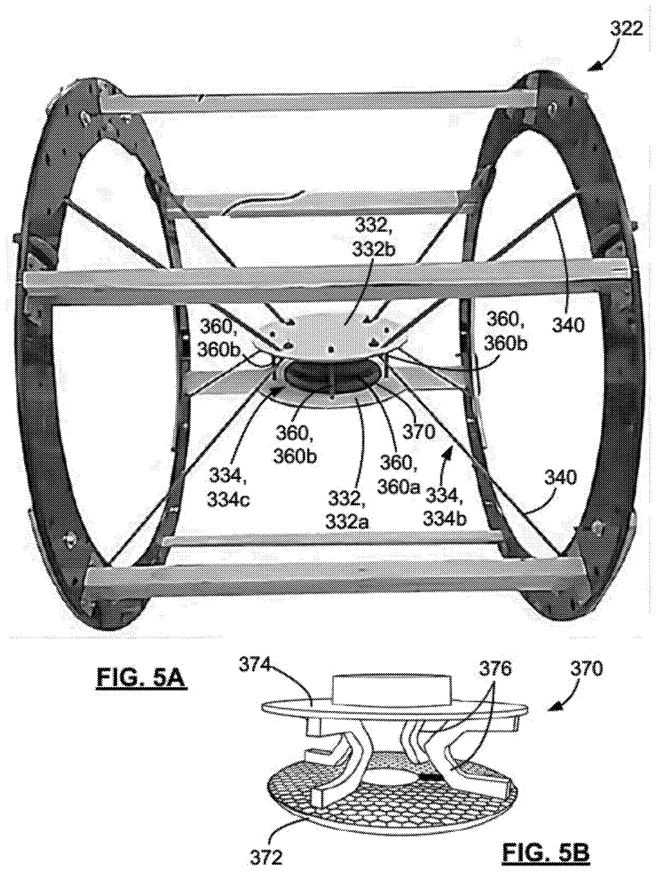

Referring now to FIGS. 5A and 5B, illustrated is a portion of another example of a geophysical survey receiver support system which has similarities to the geophysical survey receiver support system 120, and like features are indicated with like reference characters, incremented by 200.

The geophysical survey receiver support system has a suspension frame 322 from which a coil frame is suspended by a suspension system in use. The suspension system includes a plurality of elastic interlink stages 334 arranged in series whereby the coil frame is suspended from the suspension frame 322. The suspension system also includes a plurality of intermediate support members 332 providing connection locations for elastic interlinks of the elastic interlink stages 334.

In the illustrated example, the elastic interlink stages 334 includes an intermediate stage 334c between two intermediate support members 332. The intermediate stage 334c includes an elastic interlink 360 by which the two intermediate support members 332 are joined. In the illustrated example, the intermediate stage 334c includes a damper 370 forming a first type 360a of elastic interlink 360. In some examples, the damper 370 is in alternative to other types of elastic interlinks and forms the only elastic interlink 360 of the stage. In some examples, an intermediate stage includes or consists of a single damper. In some examples, a plurality of dampers are arranged in parallel in an intermediate stage. In the illustrated example, the damper 370 provides support in parallel with another type 360b of elastic interlinks 360. In the illustrated example, each of the other type 360b of elastic interlinks is formed by a length of elastic tubing (e.g., hollow silicone tubing).

Referring to FIG. 5B, the example damper 370 includes a first plate member 372 and a second plate member 374 connected by links 376. The first and second plate members 372, 374 may each be honeycomb discs, e.g., from 3D print spools. The first and second plate members 372, 374 may each be formed of plastic, e.g., HDPE. In use, the first plate member 372 is secured to a first one of the intermediate support members 332 at a connection location on the first one of the intermediate support members 332. In use, the second plate member 376 is secured to a second one of the intermediate support members 332 at a connection location on the second one of the intermediate support members 332. The links 376 are discrete from one another and regularly spaced apart. The links 376 are formed of a material providing elasticity to the damper (e.g., Sorbothane™), whereby the intermediate support members 332 joined by the damper are moveable. Alternatively, the damper 370 may be solid rubber connection.

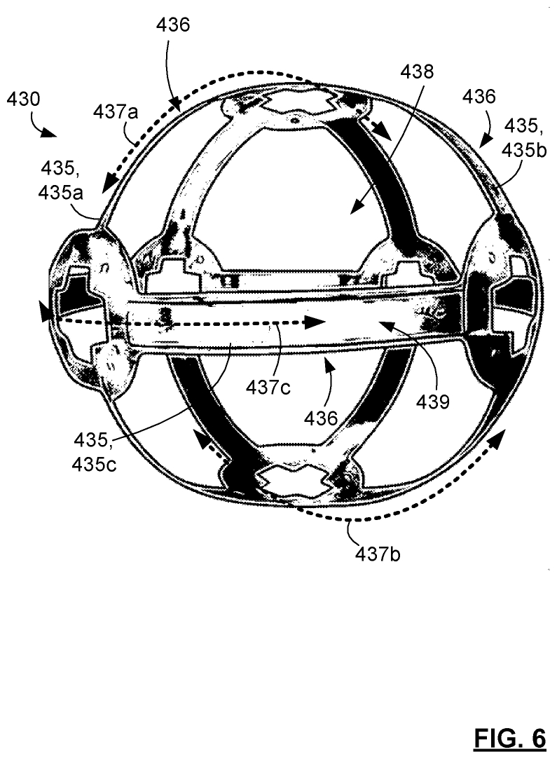

Referring now to FIG. 6, illustrated is another example of a coil frame 430. The coil frame 430 has similarities to the coil frame 130, and like features are indicated with like reference characters, incremented by 300.

The coil frame 430 is configured to support three receiver coils in positions orthogonal to one another encircling an internal space 438. The illustrated example coil frame 430 is a generally spherical coil frame which includes three coil supports 436 each forming an annular surface 435 to support a receiver coil. The coil frame 430 includes a first annular surface 435a to hold a first coil wrapped along path 437a, a second annular surface 435b to hold a second coil wrapped along path 437b, and a third annular surface 435c to hold a third coil wrapped along path 437c. The example annular surfaces 435 each include a channel 439 to hold the receiver coil.

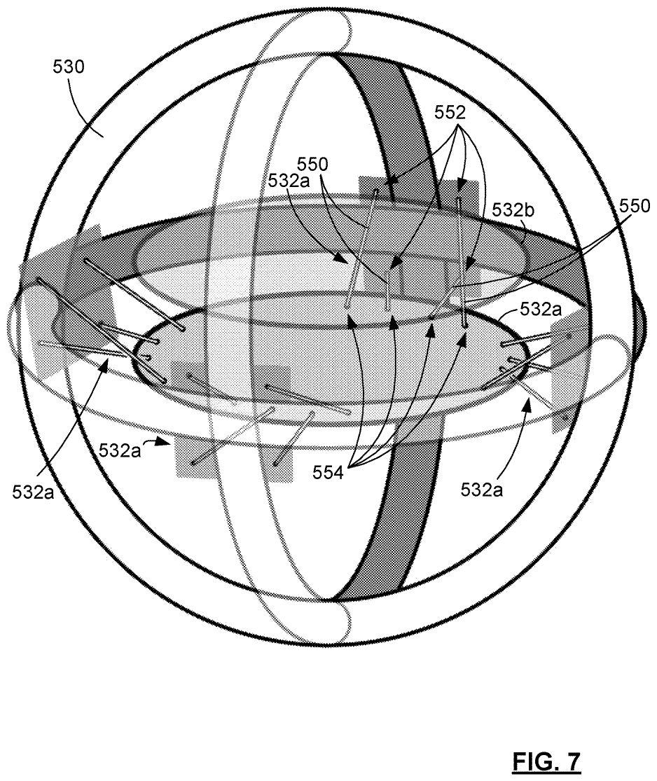

Referring now to FIGS. 7 to 9, illustrated is another example of an assembly comprising a coil frame 530, intermediate support structures 532, and elastic interlink stages 534. The coil frame 530, intermediate support structures 532, and elastic interlink stages 534 have similarities to the coil frame 130, intermediate support structures 132, and elastic interlink stages 134, and like features are indicated with like reference characters, incremented by 400.

The coil frame 530 of FIG. 7 includes integrated first connection locations 552, and a first end stage 534a joins the coil frame 530 to a first one 532a of the plurality of intermediate support structure 532. The first end stage 534a comprises elastic interlinks 550 each extending between a first connection location 552 and a second connection location 554. In the illustrated example, each interlink 550 of the first stage 532a comprises or consists of a length of material secured at one end to the first location 552 and at the opposite end to the second location 554. In some examples, the first locations 552 are each at an interface between two coils. In some examples, the first connection locations 552 each include a hole in a body of the frame 530. In some examples, the hole of the connection location 552 is a result of the manufacturing process of the coil frame 530 and is reused as part of the connection location 552.

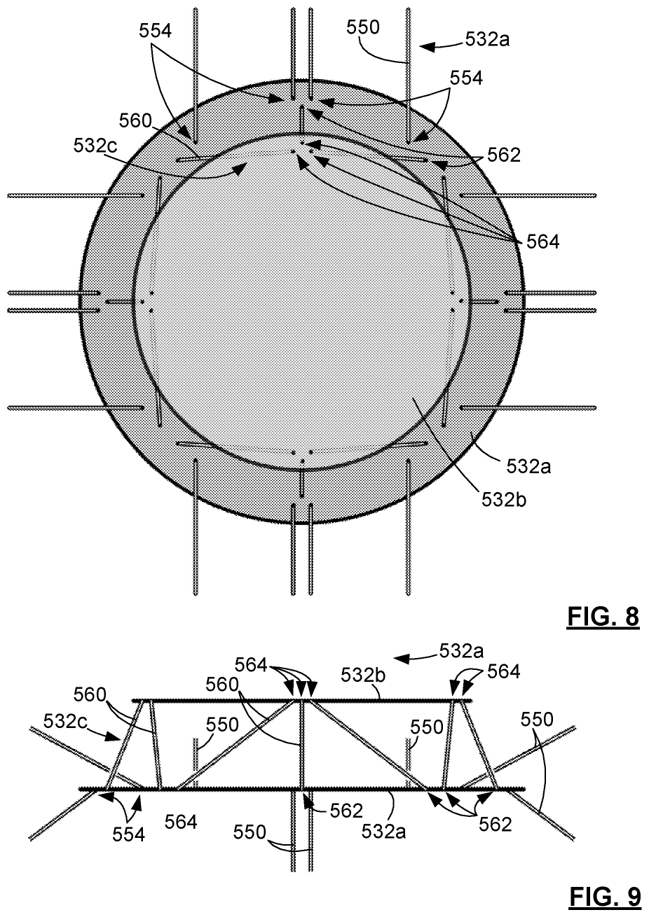

Referring now to FIGS. 8 and 9, an intermediate stage 534c joins the first one 534a and the second one 534b of the intermediate support structures 534. The intermediate stage 534c includes a plurality of elastic interlinks 560. The elastic interlinks 560 each extend between a first connection location 562 on the first one 534 of the intermediate support structures and a second connection location 564 on the second one 534b of the intermediate support structures. In the illustrated example, each interlink 560 of the intermediate stage 532c comprises or consists of a length of material secured at one end to the first location 562 and at the opposite end to the second location 564.

1. A geophysical survey receiver support system, comprising:
a. a coil frame configured to support a plurality of receiver coils; and
b. a suspension system to join the coil frame to external support points exterior to the coil frame, the suspension system including:
i. a plurality of intermediate support structures, and
ii. a plurality of elastic interlink stages arranged in series from the coil frame to the exterior whereby the coil frame is to be suspended from the external support points, the plurality of elastic interlink stages including a first end stage joining the coil frame to a first one of the plurality of intermediate support structures by a first end stage elastic interlink, a second end stage for joining the external support points to a second one of the plurality of intermediate support structures by a second end stage elastic interlink, and a further stage between the first and second intermediate support structures joining the first and second intermediate support structures via an intermediate stage elastic interlink, each of the elastic interlinks deformable and able to resume a rest shape after compression or extension, and
wherein two stages of the plurality of elastic interlink stages are disposed substantially within the coil frame.

2. The geophysical survey receiver support system of claim 1, wherein the second end stage extends between a location inside the coil frame and a location outside the coil frame.

3. The geophysical survey receiver support system of claim 2, wherein the second end stage is the only stage of the plurality of elastic interlink stages that extends substantially outside the coil frame.

4. The geophysical survey receiver support system of claim 1, wherein only two stages of the plurality of elastic interlink stages are disposed substantially within the coil frame.

5. The geophysical survey receiver support system of claim 1, wherein each stage of the plurality of elastic interlink stages includes a plurality of elastic interlinks providing parallel support.

6. The geophysical survey receiver support system of claim 5, wherein:
a. the first end stage comprises a first plurality of elastic interlinks each extending between a first end connected to the coil frame and a second end connected to the first one of the intermediate support structures,
b. the second end stage comprises a second plurality of elastic interlinks each extending between a first end connected to the second one of the intermediate support structures and a second end to be connected to an external support point of the external support points, and
c. the further stage comprises a third plurality of elastic interlinks each extending between a first end connected to the first one of the intermediate support structures and a second end connected to the second one of the intermediate support structures.

7. The geophysical survey receiver support system of claim 6, wherein the first one of the intermediate support structures is a first plate.

8. The geophysical survey receiver support system of claim 7, wherein the second one of the intermediate support structures is a second plate extending generally parallel to the first plate.

9. The geophysical survey receiver support system of claim 8, wherein each of the first plurality of elastic interlinks of the first end stage of elastic interlinks is a length of silicone extending between the first end connected to the coil frame and the second end connected to the first plate, and each of the second plurality of elastic interlinks of the second end stage of elastic interlinks is a length of silicone extending between the first end connected to the second plate and the second end to be connected to the external support point.

10. The geophysical survey receiver support system of claim 9, wherein each of the third plurality of elastic interlinks of the intermediate stage of elastic interlinks is a length of silicone extending between the first end connected to the first plate and the second end connected to the second plate.

11. The geophysical survey receiver support system of claim 10, wherein the first ends of the plurality of elastic interlinks of each stage of the plurality of elastic interlink stages are generally regularly spaced apart from each other.

12. The geophysical survey receiver support system of claim 11, wherein the second ends of the plurality of elastic interlinks of each stage of the plurality of elastic interlink stages are generally regularly spaced apart from each other.

13. The geophysical survey receiver support system of claim 12, wherein the coil frame is configured to support three coils of the plurality of receiver coils in positions orthogonal to one another and with each of the three coils encircling an internal space within which the two internal stages of the plurality of elastic interlink stages are substantially disposed.

14. The geophysical survey receiver support system of claim 13, wherein the external support points are disposed outside the coil frame with the first end of each of the second plurality of elastic interlinks of the second end stage of elastic interlinks disposed within the coil frame and the second end of each of the second plurality of elastic interlinks of the second end stage of elastic interlinks disposed outside the coil frame and joined to the external support point.

15. A method of using the geophysical survey receiver support system of claim 14, comprising:
a. suspending the coil frame from the external support points with the first plate above the second plate and the elastic interlinks of the intermediate stage under compression, and
b. performing a geophysical survey by towing, while the first plate is above the second plate, the geophysical survey receiver system behind an aircraft while collecting data from the geophysical survey receiver system.

16. A method of using the geophysical survey receiver support system of claim 14, comprising:
a. suspending the coil frame from the external support points with the second plate above the first plate and the elastic interlinks of the intermediate stage under tension, and
b. performing a geophysical survey by towing, while the second plate is above the first plate, the geophysical survey receiver system behind an aircraft while collecting data from the geophysical survey receiver system.

17. A geophysical survey receiver support system, comprising:
a. a coil frame configured to support a plurality of receiver coils;
b. a structure forming external support points exterior to the coil frame; and
c. a suspension system joining the coil frame to the external support points whereby the coil frame is suspended from the support, the suspension system including:
i. a plurality of intermediate support structures, and
ii. a plurality of elastic interlink stages arranged in series between the coil frame and the exterior support points with an intermediate support structure of the plurality of intermediate support structures at each junction between stages of the plurality of elastic interlink stages, each intermediate support structure of the plurality of intermediate support structures including a plurality of connection locations at which elastic interlinks of two sequential ones of the plurality of elastic interlink stages are connected to the intermediate support structure, and
wherein each of the plurality of connection locations of two of the plurality of intermediate support structures are disposed within the coil frame.

18. The geophysical survey receiver support system of claim 17, wherein the plurality of elastic interlink stages includes:
a. a first end stage comprising a first plurality of elastic interlinks each extending between a first end connected to the coil frame and a second end connected to a first intermediate support structure of the plurality of intermediate support structures at a subset of the plurality of connection locations of the first intermediate support structure,
b. a second end stage comprising a second plurality of elastic interlinks each extending between a first end connected to a second intermediate support structure of the plurality of intermediate support structures at a subset of the plurality of connection locations of the second intermediate support structure and a second end connected to an exterior support point of the exterior support points, and
c. a further stage comprising a damper extending between a connection location of the plurality of connection locations of the first intermediate support structure and a connection location of the plurality of connection locations of the second intermediate support structure, and
wherein the plurality of connection locations of the first intermediate support structure and the plurality of connection locations of the second intermediate support structure are disposed within the coil frame.

19. A kit of parts for assembly into a geophysical surveying receiver support system, the kit of parts including:
a. a coil frame configured to support a plurality of receiver coils;
b. a plurality of intermediate support structures;
c. a first plurality of elastic interlinks each extending between a first end to be connected to the coil frame and a second end to be connected to a first one of the plurality of intermediate support structures, the first plurality of elastic interlinks to be arranged in parallel to form a first end stage of elastic interlinks;
d. a second plurality of elastic interlinks each extending between a first end to be connected to a second one of the plurality of intermediate support structures and a second end to be connected to a suspension platform, the second plurality of elastic interlinks to be arranged in parallel to form a second end stage of elastic interlinks; and
e. a third plurality of elastic interlinks each extending between first and second ends, the third plurality of elastic interlinks to be arranged in parallel to form an intermediate stage of elastic interlinks in series between the first and second end elastic interlink stages.

20. The kit of parts of claim 19, wherein the first one of the plurality of intermediate support structures is a first plate and the second one of the plurality of intermediate support structures is a second plate, and each of the elastic interlinks of the first, second, and third pluralities of elastic interlinks is a length of silicone.
